(19) United States
(12) Patent Application Publication
(10) Pub. No.: US 2007/0076648 A1
(43) Pub. Date: Apr. 5, 2007

(54) Method and apparatus for enhanced WLAN access point bandwidth via use of a WLAN mailbox

(76) Inventor: Yean Kee Yong, Singapore (SG)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/239,904

(22) Filed: Sep. 30, 2005

(51) Int. Cl. H04Q 7/00

(52) U.S. Cl. 370/328

(57) ABSTRACT

Method and apparatus for enhanced WLAN (Wireless Local Area Network) wireless access point (AP) bandwidth via use of a WLAN mailbox. A WLAN mailbox is implemented in an integrated circuit employed by the wireless AP that is coupled to a WLAN sub-system including a WLAN controller and WLAN radio hardware for facilitating communication with WLAN stations. Packets received from a network via an Ethernet link are written by an Ethernet controller to memory blocks in the WLAN mailbox, and henceforth are forwarded to the WLAN sub-system for subsequent WLAN transmission. Packets received by the WLAN sub-system are written by a communications interface to memory blocks in the WLAN mailbox and forwarded to the Ethernet controller for transmission to a destined network. In some embodiments, MAC (Media Access Control) headers are translated between Ethernet- and WLAN-based protocols by corresponding embedded hardware in the WLAN mailbox.

### FIELD OF THE INVENTION

The field of invention relates generally to networking and, more specifically but not exclusively relates to techniques for improving the bandwidth for wireless access points employed to support Wireless Local Area Networks (WLANs).

### BACKGROUND INFORMATION

In recent years, network reach and flexibility has been greatly enhanced through the development and deployment of wireless networks. Although many different wireless protocols are now available (e.g., Wi-Fi, Bluetooth, infared, various cellular transmission schemes, WiMax, etc.), the majority of wireless networks deployed today employ wireless network components that operate under the IEEE (Instituted for Electronic and Electrical Engineers) 802.11 suite of standards.

The most numerous WLAN deployments, commonly referred to as “WiFi” (wireless fidelity) networks, employ an air interface operating in the 2.4-gigahertz (GHz) frequency range. The original Wi-Fi standard was developed by the Wireless Ethernet Compatibility Alliance (WECA), and is based on the IEEE 802.11b specification. Wi-Fi uses spread-spectrum radio waves using direct-sequence spread spectrum (DSSS) by splitting each byte of data into several parts and sending them concurrently on different frequencies. This results in a bandwidth of up to 11 megabits per second (Mb/s) when an appropriate signal strength is available. IEEE 802.11g defines a similar standard to Wi-Fi, with backward compatibility to 802.11b. However, 802.11g employs orthogonal frequency-division multiplexing (OFDM) rather than DSSS, and supports bandwidth up to 54 Mb/s. Enhanced implementations of 802.11g are asserted by their manufacturers to support transfer rates of up to 108 Mb/s. WLAN equipment employing the IEEE 802.11a standard has also been recently introduced. The 802.11a standard employs a 5 GHz air interface using an OFDM carrier.

A typical 802.11 WLAN deployment is shown in FIG. 1. Each of three wireless access points (APs) 100A, 100B, and 100C provide WLAN connectivity to various WLAN stations within respective coverage areas 101A, 101B, and 101C. In turn, each of wireless APs 100A-C is linked to a switch 102 via a respective Ethernet (IEEE 802.3) link 103A-C. In general, switch 102 is representative of various types of switches and routers present in a typical LAN, WLAN (wide LAN) or MAN (Metropolitan Area Network) that employs wireless APs to extend their network reach. In some cases, the switching operations may be facilitated via a server 105 that runs software to manage the network.

Each wireless AP 100A-C provides WLAN service to stations within its coverage area using wireless signals and protocols defined by the applicable air interface (typically 802.11b or 802.11g or both) employed for the WLAN. (For illustrative purposes, each coverage area is shown in a circular shape, although in practice, the actual shape of a particular coverage area will generally vary based on various obstacles and signal interference from external sources. Additionally, each of coverage areas 101A-C is shown to not overlap any other coverage area. Again, this is for illustrative purposes, as WLAN coverage areas often overlap.) Exemplary WLAN stations depicted in FIG. 1 include notebook computers 106, desktop computers 108, and hand-held wireless devices 110 (e.g., personal digital assistants (PDAs), pocket PCs, cellular phones supporting 802.11 links, etc.). To support station-side operations, each station provides an appropriate WLAN interface, such as depicted by a PCMCIA 802.11b or 802.11g card 112 for a notebook computer or a 802.11b or 802.11g peripheral expansion card 114 for a desktop computer. Optionally, the 802.11 wireless interface may be built-in, such as is the case with notebooks employing Intel's Centrino® chipset. Similarly, wireless handheld devices will provide built-in 802.11 interfaces.

A wireless AP provides a basic and extended service set to one or more stations that communicate with the AP. The AP facilitates and coordinates communication and channel access between stations, and provides an access mechanism for the stations to access various land-based networks via switch 102, such as depicted by enterprise network 116 and Internet 118. Stations authenticated and associated with an AP typically do not operate in a peer-to-peer mode—communication from one station to another are routed through the AP. Thus, the AP serves as a relay station for data traffic between stations within its coverage area by providing a routing function on the WLAN side. Furthermore, an AP provides another routing function pertaining to the routing of downlink traffic originating from an upstream network (such as enterprise network 116 and Internet 118, as well as traffic originating from other APs) and destined for a WLAN station served by the AP.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram of an exemplary network implementation in which Ethernet networks are extended using three wireless access points, each hosting a respective WLAN;

FIG. 2 is a schematic diagram illustrating various functional blocks employed by a wireless access point (AP);

FIG. 3 is a schematic diagram illustrating a wireless AP employing a network processor unit (NPU) having a conventional architecture;

FIG. 4 is a flowchart illustrating operations performed in connection with forwarding a packet received from an Ethernet network to be transmitted to a WLAN station via a wireless AP employing the conventional architecture of FIG. 3;

FIG. 5 is a flowchart illustrating operations performed in connection with forwarding a packet received from a WLAN station to be transferred to an Ethernet network via a wireless AP employing the conventional architecture of FIG. 3;

FIG. 6 is a schematic diagram of a wireless AP architecture including an NPU employing a WLAN mailbox, in accordance with embodiments of the invention;

FIG. 7 is a schematic diagram illustrating communication mechanisms between various WLAN components and other NPU and wireless AP components;

FIG. 8 flowchart illustrating operations performed in connection with forwarding a packet received from an Ethernet network to be transmitted to a WLAN station via a wireless AP employing the architecture of FIGS. 6 and 7;

FIG. 9 is a flowchart illustrating operations performed in connection with forwarding a packet received from a WLAN station to be transferred to an Ethernet network via a wireless AP employing the architecture of FIGS. 6 and 7;

FIG. 10a shows an IEEE 802.3 frame format; and

FIG. 10b shows an IEEE 802.11 frame format.

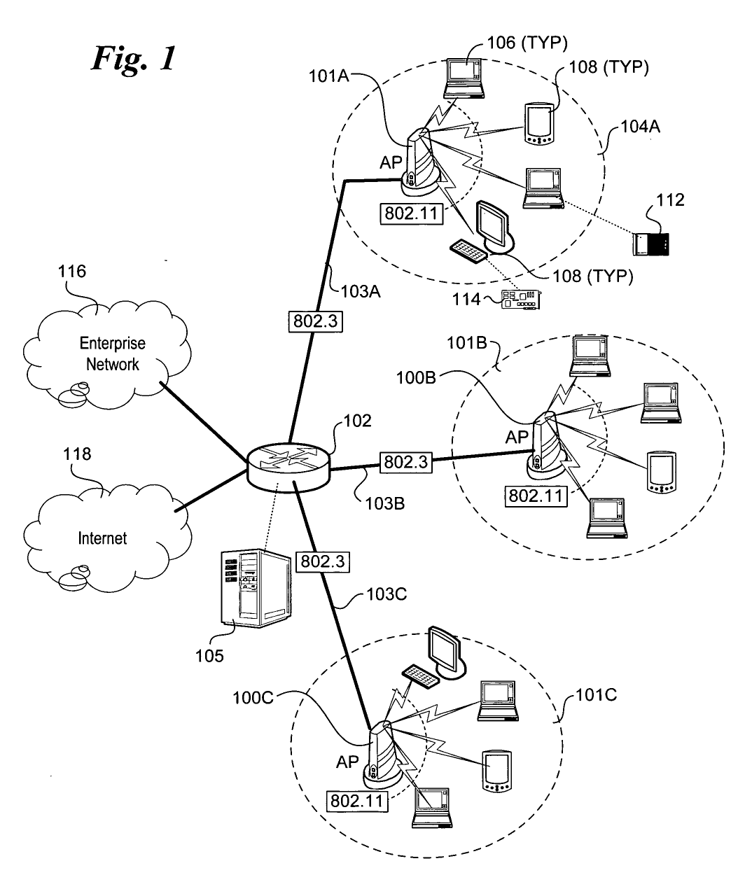

### DETAILED DESCRIPTION

Embodiments of methods and apparatus for enhancing WLAN access point bandwidth are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

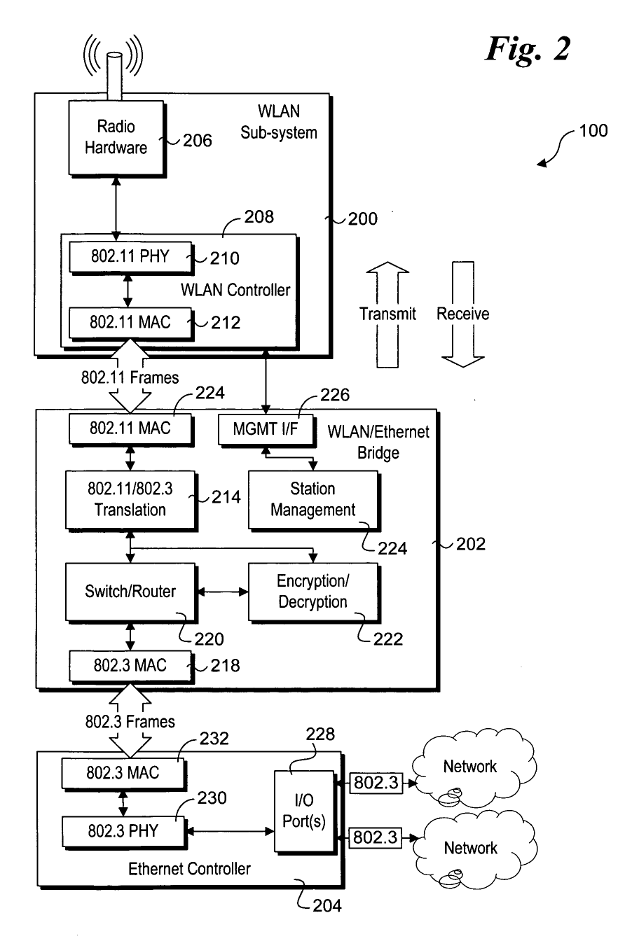

FIG. 2 shows a block diagram illustrating the principle functional blocks of a wireless access point. At the top level, the blocks include a WLAN sub-system 200, a WLAN/Ethernet bridge 202, and an Ethernet controller 204. The WLAN sub-system generally includes components use to facilitate WLAN operations at the PHY (Physical) layer, as well as control of the 802.11 air interface. For simplicity, these components are depicted as including radio hardware 206 and a WLAN controller 208. As used herein, the WLAN radio hardware comprise the components of a wireless AP used to generate and process radio signals that are employed for the air interface to facilitate communications between the AP and WLAN stations. Such components will typically include an antenna, as well and analog and digital circuitry for generating outgoing and processing received radio frequency (RF) signals in accordance with the applicable WLAN protocol(s) employed by the AP.

The WLAN controller is further depicted as including an 802.11 PHY block 210, and an 802.11 MAC (Media Access Control) block 212. As will be recognized by those skilled in the networking arts, the PHY and MAC blocks are respectively associated with the Physical and Data Link layers, which comprise the two lowest layers (layer-1 and layer-2) in the seven-layer OSI (Open System Interconnect) network communication model.

As its name implies, WLAN/Ethernet bridge is employed as a bridge between 802.11 WLAN signals and 802.3 Ethernet signals. More particularly, in the illustrated architecture, WLAN/Ethernet bridge 202 provides an interface between 802.11 frames passed to and from the WLAN sub-system, and 802.3 frames passed to and from Ethernet controller 204. This is facilitated, in part, by an 802.11/802.3 translator 214, which translates frame formats between 802.11 and 802.3 and vice-versa. As an option, the frame translation operations may be performed by WLAN controller 208.

As discussed above, an access point may also need to perform switching and/or routing functions. At one level, switching operations are performed via WLAN sub-system 200, such as managing access to the WLAN channel(s) using collision avoidance mechanisms and the like, since by its nature, the WLAN air interface comprises a shared medium necessitating some type of switching mechanism. Additionally, the AP must perform switching/routing operations, wherein packets received at an input side of an input/output (I/O) port are routed to either an appropriate destination station via the WLAN sub-system or to another I/O port to be transferred to another network. For illustrative purposes, the switching and routing operations are depicted in FIG. 2 as being performed by a switch/router block 220 on WLAN/Ethernet bridge 202; however, it will be understood that some of the switching and routing operations may be performed by Ethernet controller 204.

Another operation typically provided by an access point relates to security. Not only is a WLAN signal sent over a shared medium, it may be accessed (at the signal level) by any station within the AP's coverage area, regardless of whether that station is authorized or not to access the AP. Accordingly, to control AP access, various security schemes are implemented, such as WEP (Wired Equivalent Privacy) and WPA (Wi-Fi Protected Access) schemes. Under these schemes, packets are encrypted using some security key infrastructure, such as shared keys, rotating keys, etc. At the same time, Ethernet transmissions are typically are either a) not encrypted or b) encrypted using decryption/encryption managed by the transmission endpoints rather than the AP (e.g., Virtual Private Connections, Secure Socket Layer security, etc.) To facilitate the encryption and decryption operations necessary to support secure WLAN traffic, WLAN/Ethernet bridge 202 also includes an encryption/decryption block 222. Generally, some or all of the operations illustrated by encryption/decryption block 222 may be performed by WLAN sub-system 200, depending on the particular AP architecture.

Another operation provided by an AP is station management. For example, prior to being permitted access to AP services, a station typically needs to perform a registration operation or the like. During this process, the MAC address of the station will be acquired and the station will be identified/authenticated, an IP (Internet Protocol) address of the station will be dynamically or statically allocated and stored in an MAC-to-IP address translation table access by switch/router 220, and other related operations are performed. The station management operations are collectively depicted as being performed by a station management block 224, which access WLAN controller 208 via a management interface 226.

The Ethernet controller 204 is used to provide the interface between the AP and various networks to which the AP is communicatively coupled via corresponding network infrastructure, such as switched, bridges, routers, etc. To facilitate these operations, the Ethernet controller typically includes one or more I/O ports 228, an 802.3 PHY block 230, and an 802.3 MAC block 232. In general, I/O ports 228 will be coupled to one or more networks via corresponding IEEE 802.3 (Ethernet) links. Accordingly, such ports are alternately referred to as Ethernet ports or Ethernet I/O ports. In other instances, an Ethernet port name includes its underlying transmission rate, such as a GigE (Gigabit per second Ethernet) port for for Ethernet ports supporting GigE transmission rates.

As depicted by the Transmit and Receive arrows adjacent to WLAN sub-system 200, the “direction” of the forwarding operations described herein are from the viewpoint of the AP relative to the WLAN stations. Accordingly, transmit operations are performed to forward packets received from an Ethernet link at an AP to a WLAN station, while receive operations are performed to forward packets received from a WLAN station to be forwarded through the AP to a network via an Ethernet link.

The partitioning of the functional blocks illustrated in FIG. 2 is merely for illustrated purposes. Generally, the functional blocks may be implemented on one or more physical components, such as integrated circuits and analog circuitry corresponding to radio hardware 206. In some implementations, such as discussed below, the functional blocks of WLAN/Ethernet Bride 202 and Ethernet controller 204 will be combined on a single integrated circuit. Under such implementations, there will not be a duplication of an 802.3 MAC block, such as depicted by 802.3 MAC blocks 218 and 232 in FIG. 2.

Typically, the operations depicted by all or a portion of the various functional blocks depicted for the WLAN/Ethernet bridge are facilitated via execution of corresponding software modules that are executed on an embedded processor or the like. While this affords some degree of flexibility, it increases network latency and decreases AP throughput. This is due, in part, to latencies caused by memory access bottlenecks, as well as latencies inherent in software-based functions, such as 802.11/802.3 translation.

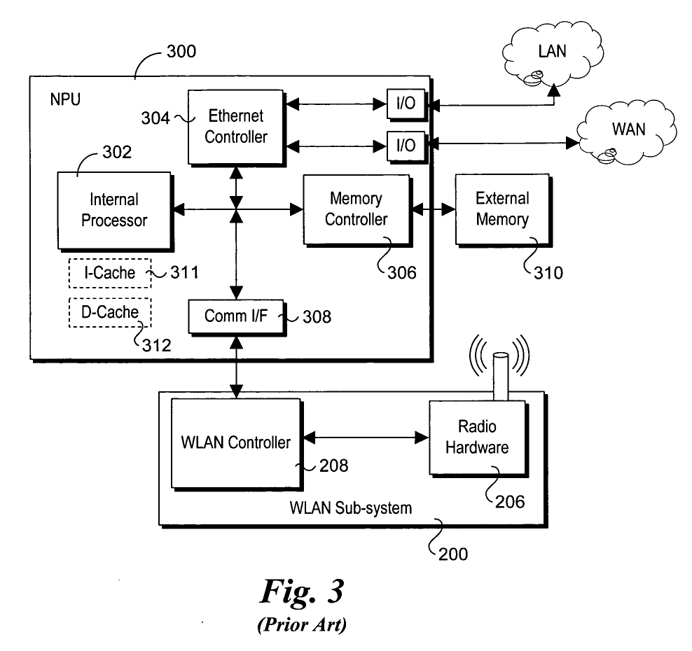

FIG. 3 shows a conventional AP architecture employing a Network Processor Unit (NPU) 300 that is used to perform functions generally analogous to those described above for WLAN/Ethernet Bridge 202 and Ethernet controller 204 of FIG. 2. NPU 300 includes an internal processor 302 coupled to an Ethernet controller 304, a memory controller 306, and a communication interface 308 via an internal bus structure or the like. The memory controller 306 provides access to an external memory 310, which will typically comprise some type of DRAM-(Dynamic Random Access Memory) based memory, such as DDRDRAM (double data-rate DRAM), SDRAM (Synchronous DRAM), RDRAM (Rambus DRAM), etc. Communication interface 308 provides an interface to WLAN controller 208. In general, this interface may be some type of bus- or serial-based interface.

In general, internal processor 302 may employ various types of instruction and data caching operations using well-known caching techniques. Accordingly, NPU 300 is depicted to further include an optional instruction cache (I-cache) 311 and an optional data cache (D-cache) 312.

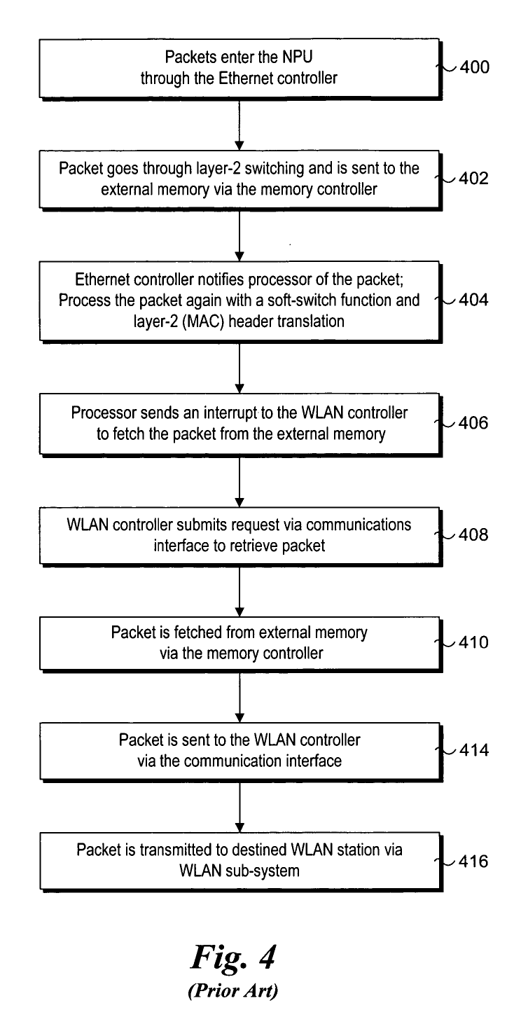

With further reference to FIG. 4, transmit packet-forwarding operations corresponding to packets received at an I/O port of the AP of FIG. 3 proceed as follows. First, in a block 400, the packets enter the NPU through Ethernet controller 304. The packet then goes through layer-2 switching (as necessary) and is sent to external memory 310 via memory controller 304, as depicted in a block 402. Layer-2 switching is employed to determine which port the packet is to be transmitted from to reach it next hop or final destination. In the case of an AP having multiple I/O ports, a packet may be switched from an incoming Ethernet connection through a first I/O port to an outgoing Ethernet connection via a second I/O port, in addition to packets that are switched from an incoming connection to the WLAN sub-system for transmission to a WLAN station. In this latter case, the WLAN sub-system represents a virtual port from the viewpoint of the switching logic.

Continuing at a block 404, after the packet has been sent to external memory 310, Ethernet controller 404 notifies processor 302 of the packet's presence. In response, the packet header information is read from external memory 310 and the packet is processed again with a soft-switch function and layer-2 header translation from an 802.3 MAC header to an 802.11 MAC header. In the manner discussed above, the header translation operation is performed by executing a corresponding software module on internal processor 302.

Next, at a block 406, processor 302 sends an interrupt to WLAN controller 208 via communications interface 308 to fetch the packet from external memory 310. In response in a block 408, the WLAN controller submits a request to retrieve the packet via communications interface 308 to memory controller 306. The packet is then fetched from external memory 310 via memory controller 304 in a block 410, and sent to WLAN controller 208 via communications interface 308 in a block 414. At this point, the packet is transmitted to a destined WLAN station via WLAN sub-system 200, as depicted in a block 416.

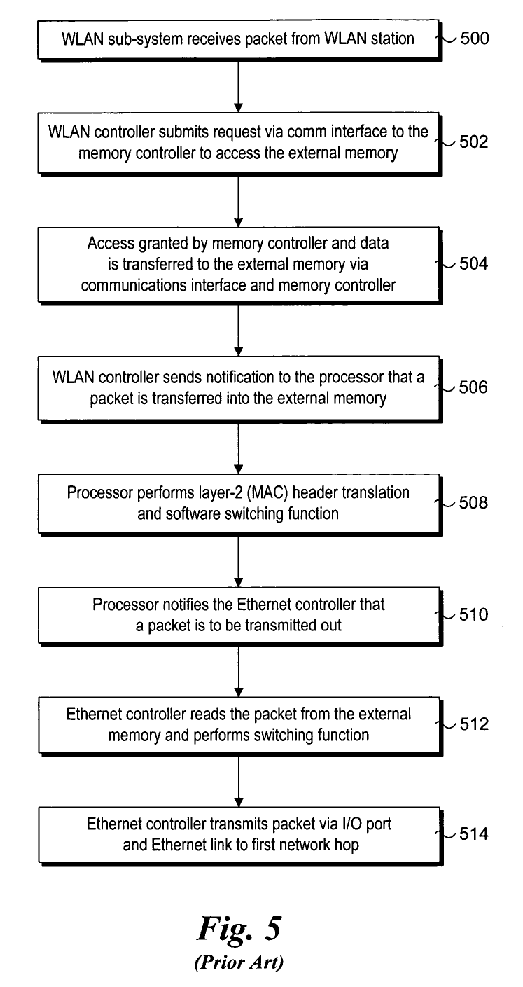

With reference to FIG. 5, receive packet-forwarding operations corresponding to packets received from WLAN stations to be forwarded through the AP of FIG. 3 to a network via an Ethernet link proceed as follows. In a block 500, WLAN sub-system 200 receives a packet from a WLAN station. In response, the WLAN controller 208 performs some initial packet processing and submits a request via communications interface 308 to memory controller 306 to access external memory 310, as depicted by a block 502. In a block 504, the memory controller grants access to WLAN controller 208, and the packet data is transferred to external memory 310 via communications interface 308 and memory controller 306.

Continuing at a block 506, the WLAN controller next sends notification to internal processor 302 that a packet has been transferred to external memory 310. The processor then performs layer-2 header translation and a software switching function on the packet in a block 508. In a block 510, the processor notifies Ethernet controller 304 that a packet is ready to be transmitted out. The Ethernet controller than reads the packet from external memory 310 and performs a switching function (as necessary) in a block 512 to direct the packet to the appropriate I/O port. The receive forwarding process is completed in a block 514, with the Ethernet controller transmitting the packet via the I/O port and Ethernet link to a first network hop along the path to the destined packet recipient.

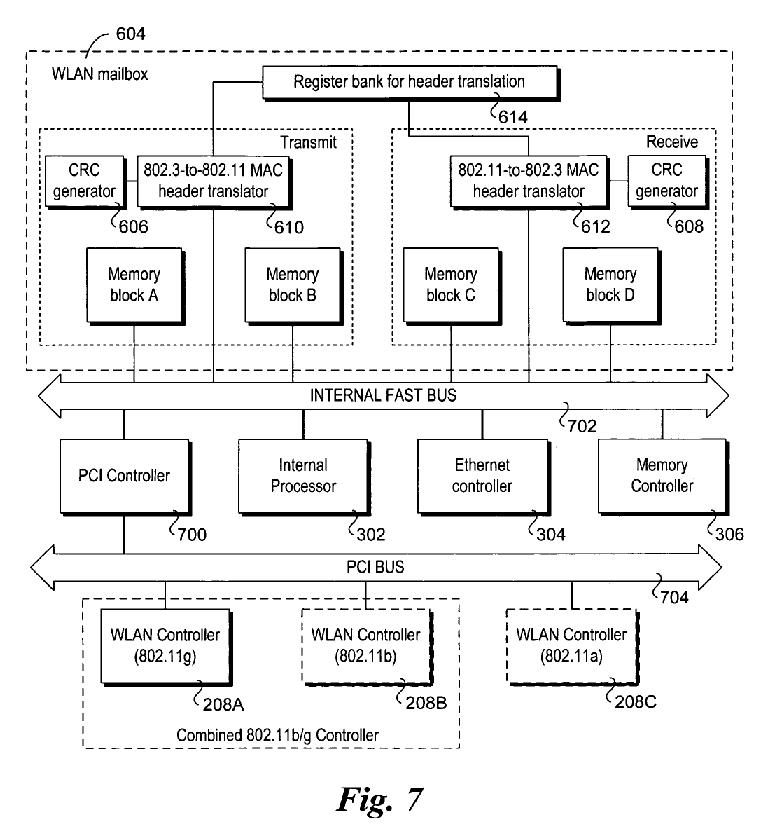

Each of the foregoing packet-forwarding processes introduces excessive latency during the transfer of packets between the NPU and the WLAN controller. This reduces the overall bandwidth of the wireless AP. The problem becomes more severe when multiple WLAN controllers are connected to the NPU via a single communication interface (such as in the configuration described below with reference to FIG. 7), and/or when there are multiple processes contending for access to the external memory.

In accordance with aspects of the embodiments now described, the aforementioned transfer latencies are significantly reduced via employment of a WLAN “mailbox,” which provides built-in packet-processing capabilities that enables some of the tasks performed by the conventional architecture of FIG. 3 to be offloaded from the internal processor and the memory controller. Offloading of these tasks provides several advantages, including reducing the processor workload and reducing the number of memory accesses to the external memory.

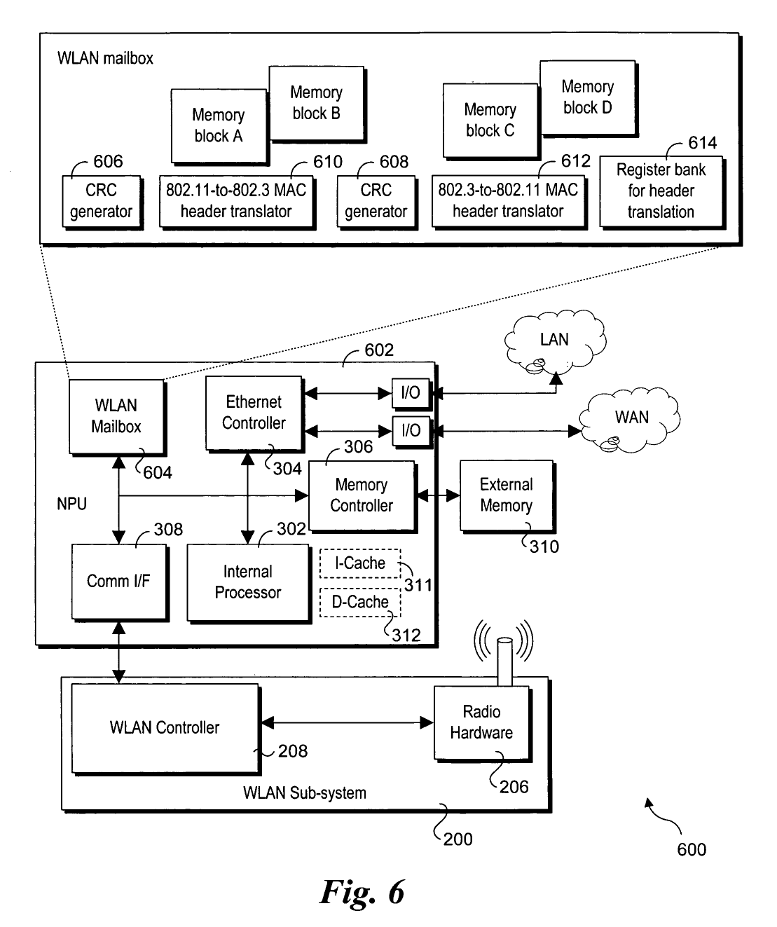

An exemplary AP architecture 600 that employs a WLAN mailbox in accordance with one embodiment of the invention is shown in FIG. 6. AP architecture 600 employs an NPU 602 coupled to a WLAN sub-system 200 including a WLAN controller 208 and radio hardware 206. As before, NPU 602 includes an internal processor 302, an Ethernet controller 304, a memory controller 306, a communications interface 308, which are communicatively-coupled to one another via associated bus structures. Also as before, NPU 602 may further include an optional instruction cache (I-cache) 311 and an optional data cache (D-cache) 312.

In addition to these components, NPU 602 includes a WLAN mailbox 604. The WLAN mailbox provides built-in computation and storage capabilities that are employed to offload packet-forwarding tasks, as described in further detail below. The capabilities are facilitated via associated functional blocks and components, as depicted toward the top of FIG. 6. In the illustrated embodiment, these include CRC (cyclic redundancy check) generators 606 and 608, an 802.11-to-802.3 MAC header translator 510, an 802.3-to-802.11 MAC header translator 512, a register bank 514, and memory blocks A, B, C, and D. It is noted in another embodiment, packet frame translation is performed by the WLAN sub-system. Accordingly, the WLAN mailbox in this embodiment will only include memory blocks A-D.

As shown in FIG. 7, in one embodiment communications interface 308 (FIG. 6) comprises a PCI (Peripheral Component Interconnect) controller 700, which interfaces to various components of the WLAN mailbox via an internal fast bus 702. The internal fast bus also supports communication between the WLAN mailbox components and internal processor 302, Ethernet controller 304, and memory controller 310. According to further aspects of this embodiment, the WLAN mailbox components and functional blocks are grouped into two sets: 1) a Transmit set; and 2) a Receive set. The Transmit set of components and functional blocks are used during WLAN transmit packet-forwarding operations, while the Receive set is used for WLAN receive packet-forwarding operations.

PCI controller 700 employs a PCI bus 704 to communicate with other components coupled to the PCI bus using PCI control and data signaling. In one embodiment, PCI controller communicates with WLAN sub-system 200 via a single WLAN controller 208 that includes a PCI interface. As illustrated in FIG. 7, in other embodiments two or more WLAN controllers may be coupled to PCI bus 704 and communicate with an NPU via PCI controller 700.

For example, an AP may support multiple WLAN protocols via corresponding 802.11 WLAN controllers, as depicted by respective 802.11g, 802.11b, and 802.11a WLAN controllers 208A, 208B, and 208C. Also as depicted in FIG. 7, the WLAN controller may comprise a combined 802.11b/g controller that supports both the IEEE 802.11b and IEEE 802.11g protocols. It is noted that support of multiple 802.11 WLAN protocols may also require addition of appropriate radio hardware and antennas, which are not shown in FIG. 7 for clarity.

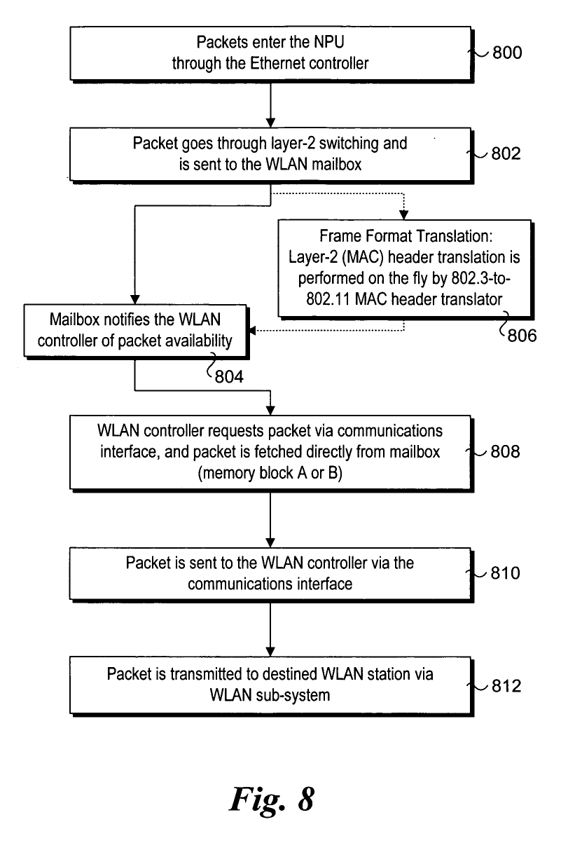

Referring now to FIG. 8, transmit packet-processing operations using AP architecture 600 proceed in the following manner. In a manner analogous with block 400 of FIG. 4, packets are received at an I/O port and enter NPU 602 at Ethernet controller 304, as depicted in a block 800. In a block 802, each packet undergoes layer-2 switching (as appropriate), with packets destined for a WLAN station sent to be stored in one of the memory blocks in WLAN mailbox 604. (Packets destined to be transmitted out another I/O port are handled in the conventional manner, e.g., stored in external memory 310). In view of the instant transmit packet-processing operations, the data is written to one of memory blocks A or B. The WLAN mailbox then notifies the WLAN controller (e.g., WLAN controller 208A) that the packet is available for transfer in a block 804.

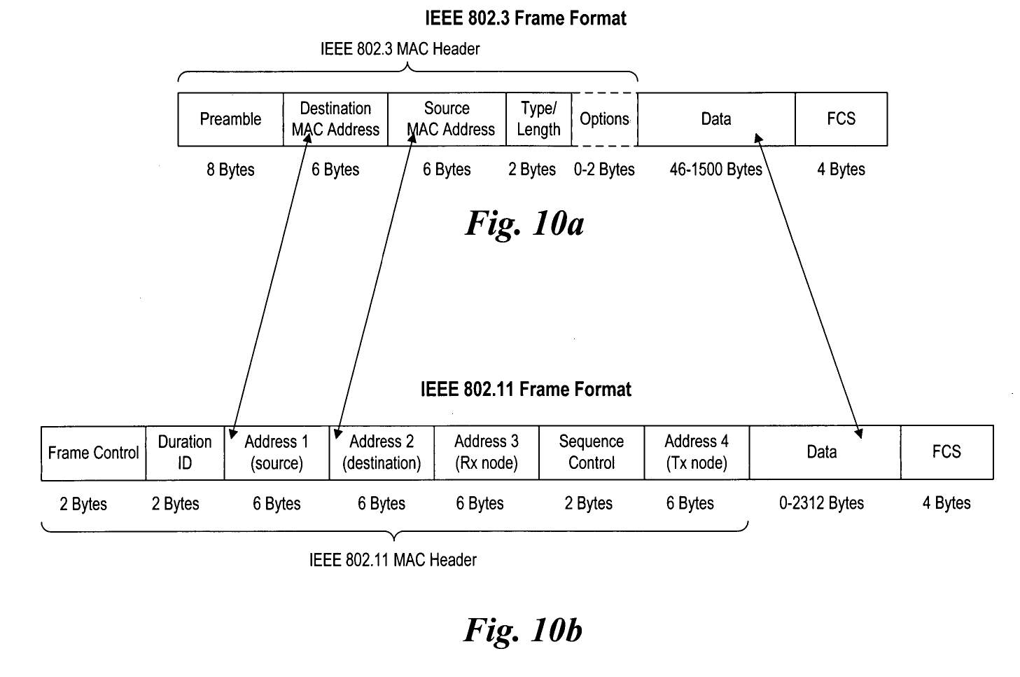

In one embodiment, as depicted by a block 806 and its associated dashed connection arrows, a layer-2 frame format translation operation is performed by the WLAN mailbox on the fly to change the frame format from the incoming Ethernet format to an applicable outgoing WLAN protocol format. This operation includes a layer-2 header translation operation performed by 802.3-to-802.11 MAC header translator 610 to translate the packet's MAC header for an 802.3 format to an 802.11 format. Further details of the MAC header translation and related frame format translation operations are discussed below with reference to FIGS. 10a and 10b. In general, the operation of block 806 may be performed prior to providing notification of packet availability in block 804, or at least some portions of the operations of these blocks may be performed in parallel. For example, since each of these operations has a predetermined latency (within a given range), notification of the WLAN controller may commence prior to completion of the frame format translation operation in a manner under which the frame format translation has completed by the time the WLAN controller is ready to receive the translated packet.

As discussed above, in some wireless AP architectures the frame format translations are performed by the WLAN sub-system. Accordingly, the operation of block 806 is not employed for such architectures.

As depicted in blocks 808 and 810, in response to the notification of block 804, the WLAN controller requests the packet via the communication interface, and the packet data is fetched directly from the memory block (in which it was stored in block 802) in the WLAN mailbox and sent to the WLAN controller via the communications interface. The packet is then transmitted to its destined WLAN station via WLAN sub-system 200, as depicted in a block 812.

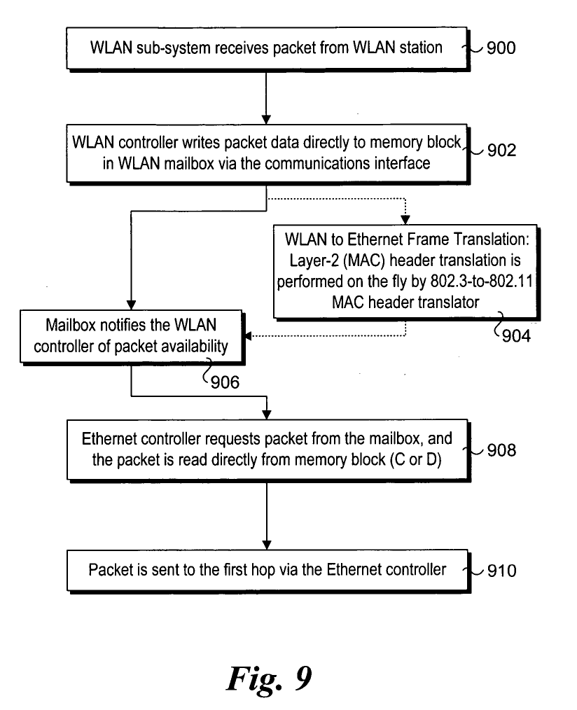

FIG. 9 shows a flowchart illustrating operations that are performed in connection with one embodiment of receive packet forwarding under AP architecture 600. The processing begins in a block 900, with WLAN sub-system 200 receiving a packet from a WLAN station. In response in a block 902, the WLAN controller writes the packet data directly to a memory block (C or D) in the WLAN mailbox via the communications interface (e.g., PCI controller 700 in one embodiment).

The operations of blocks 904 and 906 are substantially analogous to the operations of blocks 804 and 806 discussed above, except the frame format translation is now from a WLAN-based format to an Ethernet format. More particularly, in block 906 the frame format is translated from a WLAN-base protocol to an Ethernet protocol. Accordingly, in the illustrated embodiment, the frame format translation includes a layer-2 MAC header translation that is performed on the fly using 802.11-to-802.3 MAC header translator 612. As before, under embodiments that perform frame format translations via the WLAN controller, the operation of block 906 is bypassed. Also as before, a portion of the operation of block 906 may be performed in parallel with the notification operation of block 904.

In response to the notification of block 904, Ethernet controller 700 requests the packet from the WLAN mailbox, and the packet is read from the memory block (C or D) in which it was previously stored. Subsequently, in a block 910, the packet is sent to the first hop in the Ethernet network via Ethernet controller 304.

The formats for an 802.3 frame format and an 802.11 frame format are respectively shown in FIGS. 10a and 10b. The 802.3 frame format includes an 8-byte Preamble, 6-byte Destination and Source MAC address fields, a 2-byte Type/Length field, an optional (up to 2-bytes) Options field, a 46-1500 byte Data field, and a 4-byte Frame Check Sequence (FCS) field. The Options field may be present if the Type/Length field value is 0x8100 (the value for a VLAN (Virtual LAN) TPID (Tag Protocol Identifier). In this case, the Type/Length field will be replaced with the VLAN extension frame.

The 802.11 frame format includes a 2-byte Frame Control field, a 2-byte Duration ID, 6-byte Address 1, 2, 3, and 4 fields, a 2-byte Sequence Control field, a 0-2312 byte Data field, and a 4-byte FCS field. Address 1 corresponds to the MAC address of the source of the WLAN transmission. Address 2 corresponds to the MAC address of the destination of the WLAN transmission. Address 3 corresponds to the MAC address of the receiving WLAN station. Address 4 corresponds to the MAC address for the transmitting WLAN station.

Another aspect of the frame format translation corresponds to generating the FCS field value. The CRC generators (606 and 608) are employed for generating a cyclic redundancy check value, which is calculated over the entire MAC frame. It is used to verify the integrity of the frame at a next hop. Upon receiving a frame, the CRC for the frame is recalculated and compared with the FCS field value. A difference in the existing and recalculated FCS field values indicates the packet has been corrupted. During the MAC header translation (in either direction), a new FCS field value will be calculated using the CRC generator corresponding to the packet flow direction (Transmit or Receive), and will be appended following the data field in the translated frame.

As described above, in some embodiments layer-2 (MAC) header translation is performed on the fly during the substantially parallel operations of blocks 804 and 806 in FIG. 8 and blocks 904 and 906 in FIG. 9. Further process parallization is supported by the use of multiple memory blocks for the receive and transmit packet-forwarding processes. In one embodiment, data is written to the memory block sets (A and B or C and D) in an alternating “ping pong” manner. Under a parallel pipeline processing approach, transmit and receive packet forwarding operations are performed using processes with predefined latencies in a parallel manner that reduces the overall latency of the entire forwarding process. In accordance with this concept, data is written to and read from the memory block sets in an alternating manner, such that there is no contention for memory block access. Furthermore, since the memory blocks are sized (in one embodiment) to hold 2400 bytes, they are sufficient in size to store the maximum transfer unit (MTU) of both 802.11 packets (2346 bytes) and 802.3 packets (1518 or 1522 bytes with Virtual LAN). Furthermore, in one embodiment of internal fast bus 702, separate read and write data buses are provided, thus supporting concurrent read and write memory transactions. Accordingly, data may be written to one memory block in a memory block pair, while a concurrent (or at least partially overlapping) read operation on the other memory block is performed.

The packet-forwarding schemes in accordance with the embodiments disclosed herein provide several advantages over the conventional techniques. The schemes increase the bandwidth of packet transfer between the WLAN controller(s) and the NPU. This becomes even more advantages when multiple WLAN controllers are employed in the same AP, and is particularly valuable in view of the increased use of 802.11g and 802.11a WLANs. The schemes also reduce packet-forwarding latencies.

In accordance with one aspect, packet data is transferred between the Ethernet controller and the communications interface (via the use of associated programmed logic in the NPU) in a manner that bypasses the conventional memory controller/external memory storage mechanism. This avoids the bottlenecks and latencies associated with employing the external memory for storing packet data.

In accordance with another aspect implemented by some embodiment, by removing the need for the processor to perform layer-2 header translation, packet arriving from the WLAN sub-system may be quickly forwarded to the Ethernet controller for switching, while packets arriving at the wireless AP that are destined for a WLAN station may be quickly forwarded to the WLAN sub-system with minimal latency. Furthermore, the processor can offload some of the software switching functions directly to the Ethernet controller. Hence, many of the packets will not need to be written to the external memory if the packet to be routed between a WLAN station and an Ethernet I/O port. This is very important for time critical packets such as voice or video data.

As another advantage, the schemes reduce the need for the internal processor to have large caches, since a large part of the processing performed (e.g., layer-2 header translation) is now done easily by the header translation units in the WLAN mailbox. Furthermore, since the processor does not need to perform layer-2 header translation and to some extent switching functions, the processor may be run at lower clocking speeds, thus reducing power consumption.

In general, the operations performed by the various functional blocks and components of the WLAN mailbox may be implemented on an integrated circuit (IC) using well-known semiconductor manufacturing processes. Furthermore, the various WLAN mailbox functional blocks may be implemented via hardware-based (e.g., gate-level) programmed logic, software running on an embedded compute element, or a combination of the two. In one embodiment, the 802.3-to-802.11 MAC header translator 610 and the 802.11-to-802.3 MAC header translator 612 are implemented via programmed logic to perform hardware-based MAC header translations. Similarly, programmed logic is implemented to facilitate the forwarding and storage a packets under the WLAN mailbox architectures described herein.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method, comprising:
receiving a packet at an input/output (I/O) port coupled to an Ethernet controller of a Wireless Local Area Network (WLAN) wireless access point (AP) including a WLAN sub-system;
writing the packet from the Ethernet controller to a memory block of a WLAN mailbox; and
forwarding the packet from the memory block in the WLAN mailbox to the WLAN sub-system in the wireless AP.

2. The method of claim 1, further comprising:
employing a hardware-based translator associated with the WLAN mailbox to translate the packet from an Ethernet-based protocol frame format to a WLAN protocol frame format.

3. The method of claim 1, wherein the WLAN mailbox includes multiple memory blocks, the method further comprising:
writing data corresponding to respective packets received at the I/O port to first and second memory blocks in the WLAN mailbox in an alternating manner.

4. The method of claim 1, wherein the WLAN mailbox includes multiple memory blocks, the method further comprising:
reading data corresponding to a first packet received at the I/O port from a first memory block in the WLAN mailbox; and
concurrently writing data corresponding to a second packet received at the I/O port to a second memory block in the WLAN mailbox.

5. The method of claim 1, wherein the wireless AP includes multiple I/O ports, the method further comprising:
receiving a packet at a first I/O port;
performing a layer-2 switching operation to determine whether the packet is to 5 be forwarded to the WLAN sub-system or to be transmitted out a second I/O port;
and if the packet is to be forwarded to the WLAN sub-system,
writing the packet to the memory block in the WLAN mailbox and forwarding the packet from the memory block in the WLAN mailbox to the WLAN sub-system.

6. The method of claim 1, wherein the WLAN protocol comprises at least one of the IEEE (Institute of Electronic and Electric Engineers) 802.11b, IEEE 802.11g, and IEEE 802.11a WLAN protocols.

7. A method, comprising:
receiving a packet from a Wireless Local Area Network (WLAN) station at a WLAN sub-system of a wireless access point (AP) having a WLAN mailbox and an Ethernet controller coupled to at least one input/output (I/O) port;
sending the packet from the WLAN sub-system to the WLAN mailbox and storing the packet in a memory block of the WLAN mailbox; and
forwarding the packet from the memory block to the Ethernet controller to be transmitted out an I/O port.

8. The method of claim 7, further comprising:
employing a hardware-based translator associated with the WLAN mailbox to translate the packet from an WLAN protocol frame format to an Ethernet-based protocol frame format.

9. The method of claim 7, wherein the WLAN mailbox includes multiple memory blocks, the method further comprising:
writing data corresponding to respective packets received at the WLAN sub-system to first and second memory blocks in the WLAN mailbox in an alternating manner.

10. The method of claim 7, wherein the WLAN mailbox includes multiple memory blocks, the method further comprising:
reading data corresponding to a first packet received at the WLAN sub-system from a first memory block in the WLAN mailbox; and
concurrently writing data corresponding to a second packet received at the WLAN sub-system to a second memory block in the WLAN mailbox.

11. The method of claim 1, wherein the WLAN protocol comprises at least one of the IEEE (Institute of Electronic and Electric Engineers) 802.11b, IEEE 802.11g, and IEEE 802.11a WLAN protocols.

12. An integrated circuit, comprising:
an Ethernet controller having at least one input/output (I/O) port interface;
a communications interface;
a Wireless Local Area Network (WLAN) mailbox, comprising components communicatively coupled to the communications interface and the Ethernet controller including,
an IEEE (Institute of Electronic and Electric Engineers) 802.3-to-IEEE 802.11 Media Access Control (MAC) header translator; and
at least one memory block.

13. The integrated circuit of claim 12, further comprising:
programmed logic to implement packet forwarding operations including,
writing data corresponding to a packet received at an I/O port coupled to the at least one I/O port interface of the Ethernet controller from the Ethernet controller to a memory block of the WLAN mailbox;
translating a frame format for the packet from an IEEE 802.3 frame format to an IEEE 802.11 frame format using the IEEE 802.3-to-IEEE 802.11 MAC header translator; and
forwarding the packet from the memory block to the communications interface.

14. The integrated circuit of claim 12, wherein the WLAN mailbox further comprises at least one Cyclic Redundancy Check (CRC) generator.

15. The integrated circuit of claim 12, wherein the WLAN mailbox further comprises an IEEE 802.11-to-IEEE 802.3 Media Access Control (MAC) header translator.

16. The integrated circuit of claim 15, further comprising:
programmed logic to implement packet forwarding operations including,
transferring a packet provided to the communications interface to the WLAN mailbox and storing the packet in a memory block of the WLAN mailbox;
translating a frame format for the packet from an IEEE 802.11 frame format to an IEEE 802.3 frame format using the IEEE 802.11-to-IEEE 802.3 MAC header translator; and
forwarding the packet from the memory block to the Ethernet controller to be transmitted out an I/O port.

17. The integrated circuit of claim 12, further comprising:
an internal processor, communicatively coupled to the Ethernet controller and the communications interface; and
a memory controller, communicatively coupled to the internal processor.

18. The apparatus of claim 12, wherein the communications interface comprises a PCI (Peripheral Component Interconnect) controller.

19. A wireless access point (AP), comprising:
at least one input/output (I/O) port;
a wireless local area network (WLAN) sub-system including WLAN radio hardware coupled to a WLAN controller having a communication interface;
a network processor unit (NPU), including:
an internal bus structure;
an Ethernet controller coupled to the at least one I/O port and the internal bus structure;
a communication interface, coupled to the communication interface of the WLAN controller and the internal bus structure;
a Wireless Local Area Network (WLAN) mailbox, comprising components communicatively coupled to the internal bus structure, including,
an IEEE (Institute of Electronic and Electric Engineers) 802.3-to-IEEE 802.11 Media Access Control (MAC) header translator;
an IEEE 802.11-to-802.3 MAC header translator; and
a plurality of memory blocks;
a processor, coupled to the internal bus structure; and
a memory controller, coupled to the internal bus structure; and memory, coupled to the memory controller.

20. The wireless AP of claim 19, wherein the communication interface in the NPU comprises a PCI (Peripheral Component Interconnect) controller.

21. The wireless AP of claim 19, wherein the NPU further comprises:
programmed logic to implement packet forwarding operations including,
writing data corresponding to a packet received at an I/O port from the Ethernet controller to a memory block of the WLAN mailbox;
translating a frame format for the packet from an IEEE 803.2 frame format to an IEEE 802.11 frame format using the IEEE 802.3-to-IEEE 802.11 MAC header translator; and
forwarding the packet from the memory block to the communications interface.

22. The wireless AP of claim 19, wherein the NPU further comprises:
programmed logic to implement packet forwarding operations including,
transferring a packet provided to the communications interface to the WLAN mailbox and storing the packet in a memory block of the WLAN mailbox;
translating a frame format for the packet from an IEEE 802.11 frame format to an IEEE 802.3 frame format using the IEEE 802.11-to-lEEE 802.3 MAC header translator; and
forwarding the packet from the memory block to the Ethernet controller to be transmitted out an I/O port.
